(19) United States
(12) Patent Application Publication
(10) Pub. No.: US 2009/0082518 A1
(43) Pub. Date: Mar. 26, 2009

(54) CARBOXYL GROUP-CONTAINING POLYURETHANE, HEAT-CURABLE RESIN COMPOSITION AND USES THEREOF

(75) Inventors: Hiroshi Uchida, Kanagawa (JP); Ritsuko Hirakawa, Kanagawa (JP); Yoshio Miyajima, Tokyo (JP); Hirofumi Inoue, Tokyo (JP); Kazuya Kimura, Kanagawa (JP); Yukihiko Azuma, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato, Tokyo (JP)

(21) Appl. No.: 11/914,435

(22) PCT Filed: May 16, 2006
(86) PCT No.: PCT/JP2006/310084

§ 371 Date: Nov. 14, 2007

Related U.S. Application Data
(60) Provisional application No. 60/684,589, filed on May 26, 2005.
(60) Provisional application No. 60/684,588, filed on May 26, 2005.

(30) Foreign Application Priority Data
May 16, 2005 (JP) 2005-143293
May 16, 2005 (JP) 2005-143294

(51) Int. Cl. C08L 75/04; C08G 18/32; C08L 67/00; C09D 11/10; C09D 175/04

(52) U.S. Cl. 524/539; 528/65; 528/60; 525/418

(57) ABSTRACT

Disclosed is a carboxyl group-containing polyurethane (A) produced from a polyol (b) containing at least 10 mol % (relative to the total (100 mol %) of the polyol (b)) of a polyol (b1) which:
(i) has a number-average molecular weight of 500 to 50,000;
(ii) has 1 to 10 hydroxyl groups per molecule; and
(iii) is one or a combination of two or more polyols selected from the group consisting of polybutadiene polyol, polyisoprene polyol, hydrogenated polybutadiene polyol and hydrogenated polyisoprene polyol.

The carboxyl group-containing polyurethane (A) is suitable as materials of cured products, for example cured films, that are excellent in adhesion with substrates, low warpage, flexibility, plating resistance, soldering heat resistance and long-term reliability.

### CROSS-REFERENCE TO RELATED APPLICATIONS

This application is an application filed under 35 U.S.C. §111(a) claiming benefit pursuant to 35 U.S.C. §119(e) (1) of the filing dates of Provisional Application 60/684,588 filed May 26, 2005 and Provisional Application 60/684,589 filed May 26, 2005 pursuant to 35 U.S.C. §111(b).

### TECHNICAL FIELD

The present invention relates to a carboxyl group-containing polyurethane and a heat-curable resin composition including the polyurethane. More particularly, the invention is concerned with a carboxyl group-containing polyurethane, and a heat-curable resin composition and a coating paste including the polyurethane capable of giving cured products excellent in adhesion with substrates, low warpage, flexibility, plating resistance, soldering heat resistance and long-term reliability.

### BACKGROUND ART

Surface protective films of flexible printed circuits are for example adhesive-bonded polyimide films, called coverlay films, that are punched out with a die conforming to the pattern, and are screen-printed films of UV or heat curable overcoating resins having flexibility, with the latter being more advantageous particularly in workability. Known such curable overcoating resins include resin compositions based on epoxy resins, acrylic resins or mixtures thereof. These compositions are often based on resins modified by introduction of butadiene, siloxane, polycarbonate diol or long chain aliphatic skeletons, whereby the flexibility is improved and the warpage due to cure shrinkage is prevented while minimizing the reduction of heat resistance, chemical resistance and electrical insulating properties inherent to the surface protective films.

With recent lightweighting and miniaturization of electronic equipment, flexible substrates are reduced in weight and thickness and are therefore more significantly susceptible to the flexibility and cure shrinkage of the overcoating resin compositions. Consequently, the curable overcoating resins do not satisfy performance requirements in terms of flexibility and warpage due to cure shrinkage.

JP-A-H11-61038 (Patent Document 1) discloses a resin composition including a polybutadiene block isocyanate and a polybutadiene polyol. Cured products of the composition have good flexibility and shrinkage factor, but are insufficient in heat resistance.

JP-A-2004-137370 (Patent Document 2) discloses a polyamideimide resin produced through reaction of a polycarbonate diol and a diisocyanate compound to prepare a polyurethane having two isocyanate groups at both ends, and reaction of the diisocyanate-terminated polyurethane with trimellitic acid. Cured products of the resin have unsatisfactory electrical characteristics and long-term reliability.

JP-A-2004-182792 (Patent Document 3) discloses a polyamideimide resin with an organosiloxane skeleton. Cured products of the resin have bad adhesion to substrates. This prior art uses special solvents such as N-methyl-2-pyrrolidone, which can dissolve emulsifying agents in the screen-printing, often resulting in problems.

Patent Document 1: JP-A-H11-61038

Patent Document 2: JP-A-2004-137370

Patent Document 3: JP-A-2004-182792

### DISCLOSURE OF THE INVENTION

The present invention is directed to solving the problems in the background art. It is therefore an object of the invention to provide a carboxyl group-containing polyurethane, a solution including the carboxyl group-containing polyurethane and a solder resist ink including the solution capable of giving cured products excellent in adhesion with substrates, low warpage, flexibility, plating resistance, soldering heat resistance and long-term reliability.

It is a still further object of the invention to provide a cured product excellent in adhesion with substrates, low warpage, flexibility, plating resistance, soldering heat resistance and long-term reliability.

The present inventors studied diligently to solve the above problems, and they have arrived at a solder resist ink that includes a carboxyl group-containing polyurethane having a structure derived from a specific polybutadiene polyol, or includes a carboxyl group-containing polyurethane resulting from reaction of at least the polyol, a polyisocyanate compound and a carboxyl group-containing hydroxy compound. The solder resist ink has been found to give cured products excellent in adhesion with substrates, flexibility, plating resistance, soldering heat resistance and long-term insulating properties at high temperatures and high humidities. The present invention has been completed based on the findings. The present invention is concerned with the following [1] to [24].

[1] A carboxyl group-containing polyurethane (A) produced from a polyol (b) containing at least 10 mol % (relative to the total (100 mol %) of the polyol (b)) of a polyol (b1):

(i) having a number-average molecular weight of 500 to 50,000;

(ii) having 1 to 10 hydroxyl groups per molecule; and

(iii) being one or a combination of two or more polyols selected from the group consisting of polybutadiene polyol, polyisoprene polyol, hydrogenated polybutadiene polyol and hydrogenated polyisoprene polyol.

[2] The carboxyl group-containing polyurethane (A) as described in [1] produced by reacting:

(a) a polyisocyanate compound;

(b) a polyol (b) containing at least 10 mol % (relative to the total (100 mol %) of the polyol (b)) of a polyol (b1) which:

(i) has a number-average molecular weight of 500 to 50,000;

(ii) has 1 to 10 hydroxyl groups per molecule; and

(iii) is one or a combination of two or more polyols selected from the group consisting of polybutadiene polyol, polyisoprene polyol, hydrogenated polybutadiene polyol and hydrogenated polyisoprene polyol;

(c) a carboxyl group-containing dihydroxy compound;

(d) an optional monohydroxy compound (other than the polyol (b)); and

(e) an optional monoisocyanate compound.

[3] The carboxyl group-containing polyurethane (A) as described in [2], wherein the polyisocyanate compound (a) contains at least 10 mol % relative to the total (100 mol %) thereof of an alicyclic compound of 6 to 30 carbon atoms except the carbon atom in the isocyanate group (NCO group).

[4] The carboxyl group-containing polyurethane (A) as described in [2] or [3], wherein the polyisocyanate compound (a) is one or a combination of two or more polyisocyanate compounds selected from the group consisting of 1,4-cyclohexane diisocyanate, isophorone diisocyanate, methylenebis(4-cyclohexyl isocyanate), cyclohexane-1,3-dimethylene diisocyanate and cyclohexane-1,4-dimethylene diisocyanate.

[5] The carboxyl group-containing polyurethane (A) as described in any one of [1] to [4], wherein the polyol (b) contains at least 70 mol % relative to the total (100 mol %) thereof of polybutadiene with 1,2-repeating units and/or a hydride thereof.

[6] The carboxyl group-containing polyurethane (A) as described in any one of [1] to [5], wherein the polyol (b) is polybutadiene polyol and/or hydrogenated polybutadiene polyol having a number-average molecular weight of 500 to 5,000 and 2 to 4 hydroxyl groups per molecule.

[7] The carboxyl group-containing polyurethane (A) as described in any one of [2] to [6], wherein the dihydroxy compound (c) is 2,2-dimethylolpropionic acid and/or 2,2-dimethylolbutanoic acid.

[8] The carboxyl group-containing polyurethane (A) as described in any one of [2] to [7], wherein the monohydroxy compound (d) is one or a combination of two or more monohydroxy compounds selected from the group consisting of 2-hydroxyethyl acrylate, 2-hydroxyethyl methacrylate, allyl alcohol, glycolic acid and hydroxypivalic acid.

[9] The carboxyl group-containing polyurethane (A) as described in any one of [2] to [7], wherein the monohydroxy compound (d) is one or a combination of two or more monohydroxy compounds selected from the group consisting of methanol, ethanol, n-propanol, isopropanol, n-butanol, isobutanol, sec-butanol and t-butanol.

[10] The carboxyl group-containing polyurethane (A) as described in any one of [1] to [9], wherein the polyurethane has a number-average molecular weight of 1,000 to 200,000 and an acid value of 5 to 120 mgKOH/g.

[11] The carboxyl group-containing polyurethane (A) as described in any one of [1] to [10], wherein the polyurethane has a number-average molecular weight of 2,000 to 60,000 and an acid value of 10 to 70 mgKOH/g.

[12] A solution of carboxyl group-containing polyurethane comprising:

the carboxyl group-containing polyurethane (A) of any one of [1] to [11]; and

a solvent that is free of basic compounds and has a boiling point of not less than 120° C.

[13] The solution of carboxyl group-containing polyurethane as described in [12], wherein the solvent is one or a combination of two or more solvents selected from the group consisting of toluene, xylene, ethylbenzene, nitrobenzene, isophorone, diethylene glycol dimethyl ether, ethylene glycol diethyl ether, propylene glycol methyl ether acetate, propylene glycol ethyl ether acetate, dipropylene glycol methyl ether acetate, diethylene glycol ethyl ether acetate, methyl methoxypropionate, ethyl methoxypropionate, methyl ethoxypropionate, ethyl ethoxypropionate, n-butyl acetate, isoamyl acetate, ethyl lactate, cyclohexanone, N,N-dimethylformamide, N,N-dimethylacetamide, N-methylpyrrolidone, γ-butyrolactone and dimethylsulfoxide.

[14] The solution of carboxyl group-containing polyurethane as described in [12] or [13], wherein the solid concentration is in the range of 30 to 80 wt %.

[15] A heat-curable resin composition comprising:

(A) 100 parts by mass of the carboxyl group-containing polyurethane resin of any one of [1] to [11]; and

(B) 1 to 100 parts by mass of an epoxy resin.

[16] The heat-curable resin composition as described in [15], wherein the epoxy resin (B) is one or a combination of two or more epoxy resins selected from the group consisting of bisphenol A epoxy resins, bisphenol F epoxy resins, phenol novolak epoxy resins, o-cresol novolak epoxy resins, biphenyl epoxy resins, amine epoxy resins, heterocyclic epoxy resins and alicyclic epoxy resins.

[17] The heat-curable resin composition as described in [15] or [16], wherein the carboxyl group-containing polyurethane resin (A) has an acid value in the range of 5 to 120 mgKOH/g.

[18] The heat-curable resin composition as described in any one of [15] to [17], wherein the equivalent ratio of the epoxy groups in the epoxy resin (B) is 0.2 to 2 relative to the carboxyl groups in the carboxyl group-containing polyurethane resin (A).

[19] The heat-curable resin composition as described in any one of [15] to [18], further comprising inorganic fine particles and/or organic fine particles (C) in an amount of 1 to 90 parts by mass based on 100 parts by mass of the carboxyl group-containing polyurethane resin (A).

[20] The heat-curable resin composition as described in any one of [15] to [19], further comprising a curing agent (D) in an amount of 0.1 to 25 parts by mass based on 100 parts by mass of the carboxyl group-containing polyurethane resin (A) and the epoxy resin (B) combined.

[21] The heat-curable resin composition as described in [20], wherein the curing agent (D) is at least one compound selected from the group consisting of amines, quaternary ammonium salts, acid anhydrides, polyamides, nitrogen-containing heterocyclic compounds and organometallic compounds.

[22] A coating paste comprising:

the heat-curable resin composition of any one of [15] to [21]; and

a nitrogen-free polar solvent.

[23] A solder resist ink comprising the heat-curable resin composition of any one of [12] to [14], the heat-curable resin composition of any one of [15] to [21] or the coating paste of [22].

[24] A cured product produced by curing the solder resist ink of [23].

### EFFECT OF THE INVENTION

The carboxyl group-containing polyurethane (A), and the heat-curable resin composition, the coating paste and the solder resist ink, which include the carboxyl group-containing polyurethane (A), are suitable as materials of cured products, for example cured films, that are excellent in adhesion with substrates, low warpage, flexibility, plating resistance, soldering heat resistance and long-term reliability.

The cured product produced by curing the heat-curable resin composition, the coating paste or the solder resist ink, which include the carboxyl group-containing polyurethane (A), is excellent in adhesion with substrates, low warpage, flexibility, plating resistance, soldering heat resistance and long-term reliability.

### BEST MODE FOR CARRYING OUT THE INVENTION

The carboxyl group-containing polyurethane, the solution of the carboxyl group-containing polyurethane, the heat-curable resin composition, the coating paste, the solder resist ink, and the cured product according to the present invention will be described in detail hereinbelow.

[Carboxyl Group-Containing Polyurethane (A)]

The carboxyl group-containing polyurethane (A) of the present invention includes a structure derived from a polyol (b) containing at least 10 mol % (relative to the total (100 mol %) of the polyol (b)) of a polyol (b1) which:

(i) has a number-average molecular weight of 500 to 50,000;

(ii) has 1 to 10 hydroxyl groups per molecule; and

(iii) is one or a combination of two or more polyols selected from the group consisting of polybutadiene polyol, polyisoprene polyol, hydrogenated polybutadiene polyol and hydrogenated polyisoprene polyol.

The carboxyl group-containing polyurethane (A) may be produced from A carboxyl group-containing polyurethane (A) produced from a polyol (b) containing at least 10 mol % (relative to the total (100 mol %) of the polyol (b)) of a polyol (b1):

(i) having a number-average molecular weight of 500 to 50,000;

(ii) having 1 to 10 hydroxyl groups per molecule; and

(iii) being one or a combination of two or more polyols selected from the group consisting of polybutadiene polyol, polyisoprene polyol, hydrogenated polybutadiene polyol and hydrogenated polyisoprene polyol, and, more specifically, be produced by reacting:

(a) a polyisocyanate compound;

(b) a polyol which:
(i) has a number-average molecular weight of 500 to 50,000;
(ii) has 1 to 10 hydroxyl groups per molecule; and
(iii) is one or a combination of two or more polyols selected from the group consisting of polybutadiene polyol, polyisoprene polyol, hydrogenated polybutadiene polyol and hydrogenated polyisoprene polyol;

(c) a carboxyl group-containing dihydroxy compound;

(d) an optional monohydroxy compound (other than the polyol (b)); and

(e) an optional monoisocyanate compound.

### (a) Polyisocyanate Compound

Examples of the polyisocyanate compounds (a) include diisocyanates such as 2,4-toluene diisocyanate, 2,6-toluene diisocyanate, isophorone diisocyanate, 1,6-hexamethylene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, 2,2′-diethyl ether diisocyanate, diphenylmethane diisocyanate, (o, m or p)-xylylene diisocyanate, methylenebis(4-cyclohexyl isocyanate), cyclohexane-1,3-dimethylene diisocyanate, cyclohexane-1,4-dimethylene diisocyanate, 1,5-naphthalene diisocyanate, p-phenylene diisocyanate, 3,3′-methyleneditolylene-4,4′-diisocyanate, 4,4′-diphenyl ether diisocyanate, tetrachlorophenylene diisocyanate and norbornane diisocyanate. The diisocyanates may be used singly or in combination of two or more kinds.

The polyisocyanate compounds (a) generally have two isocyanate groups per molecule. Polyisocyanates having three or more isocyanate groups, such as triphenylmethane triisocyanate, may be used in small amounts as long as such use does not cause gelation of the polyurethane.

Of the above compounds, the use of alicyclic compounds of 6 to 30 carbon atoms except the carbon atoms in the isocyanate groups (NCO groups) leads to the cured product particularly excellent in long-term insulating reliability at high temperatures and high humidities. The alicyclic compound preferably accounts for not less than 10 mol %, preferably not less than 20 mol %, more preferably not less than 30 mol % of the polyisocyanate compound (a) (100 mol %). Examples of such alicyclic compounds include 1,4-cyclohexane diisocyanate, isophorone diisocyanate, methylenebis(4-cyclohexyl isocyanate), cyclohexane-1,3-dimethylene diisocyanate and cyclohexane-1,4-dimethylene diisocyanate.

### (b) Polyol

The polyol (b) contains at least 10 mol % (relative to the total (100 mol %) thereof) of a polyol (b1) which:

(i) has a number-average molecular weight of 500 to 50,000;

(ii) has 1 to 10 hydroxyl groups per molecule (herein, the polyol is referred to as such even when there is only one hydroxyl group.); and

(iii) is one or a combination of two or more polyols selected from the group consisting of polybutadiene polyol, polyisoprene polyol, hydrogenated polybutadiene polyol and hydrogenated polyisoprene polyol.

The molecular weight as used herein is a value in terms of polystyrene determined by GPC under conditions which will be described below.

Examples of the polyols (b1) include hydroxylated polybutadiene based on 1,4-repeating units (e.g. Poly bd R-45HT and Poly bd R-15HT manufactured by Idemitsu Kosan Co., Ltd.), hydroxylated hydrogenated polybutadiene (e.g. Polytail H and Polytail HA manufactured by Mitsubishi Chemical Corporation), hydroxylated polybutadiene based on 1,2-repeating units (e.g. G-1000, G-2000 and G-3000 manufactured by NIPPON SODA CO., LTD.), hydroxylated hydrogenated polybutadiene (e.g. GI-1000, GI-2000 and GI-3000 manufactured by NIPPON SODA CO., LTD.), hydroxyl-terminated polyisoprene (e.g. Poly IP manufactured by Idemitsu Kosan Co., Ltd.) and hydrogenated hydroxyl-terminated polyisoprene (e.g. Epol manufactured by Idemitsu Kosan Co., Ltd.). Polyhydric polyols (b) may be obtained by hydrating or epoxidizing the above polybutadienes or polyisoprenes followed by hydrolysis.

Herein, as to the polybutadienes, “1,4-repeating units” means a repeating units as shown the following formulae (1t) or (1c) and “1,2-repeating units” means a repeating units as shown the following formulae (2).

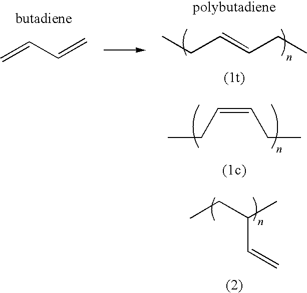

In view of the solubility of the polyurethane (A) in a solvent, the polyols having a branched skeleton are preferred, with examples including the hydroxylated polybutadiene based on 1,2-repeating units, hydroxylated hydrogenated polybutadiene, hydroxyl-terminated polyisoprene and hydrogenated hydroxyl-terminated polyisoprene. Of these, the polybutadiene based on 1,2-repeating units and/or a hydride thereof desirably accounts for not less than 20 mol %, preferably not less than 30 mol %, more preferably not less than 40 mol % of the polyol (b) (100 mol %). In view of the solubility in solvents and compatibility to other resins of the polyurethane (A), the polyols that are not hydrogenated are preferable. The polyols that are hydrogenated are preferable in view of the weathering resistance and electrical insulating properties of the cured product according to the invention.

In view of the gelation at the production of urethane, heat resistance of the product and the like, the polyols having hydroxyl groups at both ends are particularly preferable.

When the molecular weight is excessively low, the cured product cannot show desired properties. Excessively high molecular weights result in unfavorable properties, for example, in terms of the solubility of the polyurethane in a solvent, and the viscosity of the solution of the polyurethane in a solvent. The number-average molecular weight of the polyol (b) is preferably in the range of 500 to 5,000, more preferably 1,000 to 4,000.

The polyol has 1 to 10 hydroxyl groups, preferably 2 to 4 hydroxyl groups per molecule.

Particularly preferably, the polyol (b1) is polybutadiene polyol and/or hydrogenated polybutadiene polyol having a number-average molecular weight of 500 to 5,000 and 2 to 4 hydroxyl groups per molecule.

For the purposes of improving the solubility of the polyurethane in a solvent and of improving the heat resistance of the cured product according to the present invention, polycarbonate diols, polyether polyols, polyester polyols and low molecular weight diols (other than the compound (c)) may be used in combination with the polyol (b1) in an amount of 5 to 80 parts by weight with respect to 100 parts by weight of the polyol.

### (c) Carboxyl Group-Containing Dihydroxy Compound

Examples of the carboxyl group-containing dihydroxy compounds (c) include 2,2-dimethylolpropionic acid, 2,2-dimethylolbutanoic acid, N,N-bishydroxyethylglycine and N,N-bishydroxyethylalanine. Of these, 2,2-dimethylolpropionic acid and 2,2-dimethylolbutanoic acid are particularly preferable in view of the solubility in a solvent. The carboxyl group-containing dihydroxy compounds may be used singly or in combination of two or more kinds.

### (d) Monohydroxy Compound and (e) Monoisocyanate Compound

The carboxyl group-containing polyurethane (A) of the present invention may be synthesized from the aforementioned three components (a), (b) and (c). The synthesis may involve a monohydroxy compound (d) (other than the polyol (b)) and/or a monoisocyanate compound (e) for the purpose of giving radical or cationic polymerizability to the polyurethane (A) or of eliminating the influence of the isocyanate residue or the hydroxyl group at ends of the polyurethane (A).

Examples of the monohydroxy compounds (d) used forgiving radical or cationic polymerizability to the polyurethane (A) of the present invention include compounds having radically polymerizable double bonds, such as 2-hydroxyethyl (meth)acrylate, 2-hydroxypropyl(meth)acrylate, 4-hydroxybutyl(meth)acrylate, 1,4-cyclohexanedimethanol mono(meth)acrylate, adducts of the (meth)acrylates with caprolactone or alkylene oxide, glycerin di(meth)acrylate, trimethylol di(meth)acrylate, pentaerythritol tri(meth)acrylate, dipentaerythritol penta(meth)acrylate, ditrimethylolpropane tri(meth)acrylate, allyl alcohol and 2-allyloxy ethanol; and compounds having carboxylic acids, such as glycolic acid and hydroxypivalic acid.

The monohydroxy compounds may be used singly or in combination of two or more kinds. Of the above compounds, 2-hydroxyethyl(meth)acrylate, 2-hydroxypropyl (meth)acrylate, 4-hydroxybutyl(meth)acrylate, allyl alcohol, glycolic acid and hydroxypivalic acid are preferred, and 2-hydroxyethyl(meth)acrylate is more preferred.

Examples of the monohydroxy compounds (d) used for eliminating the influence of the isocyanate residue at ends of the polyurethane (A) of the present invention include the above monohydroxy compounds, methanol, ethanol, n-propanol, isopropanol, n-butanol, isobutanol, sec-butanol, t-butanol, amyl alcohol, hexyl alcohol and octyl alcohol.

Examples of the monoisocyanate compounds (e) include compounds having radical double bonds such as (meth)acryloyloxyethyl isocyanate, and monoadducts of diisocyanate compounds with 2-hydroxyethyl(meth)acrylate, 2-hydroxypropyl(meth)acrylate, 4-hydroxybutyl (meth)acrylate, 1,4-cyclohexanedimethanol mono(meth)acrylate, adducts of the (meth)acrylates with caprolactone or alkylene oxide, glycerin di(meth)acrylate, trimethylol di(meth)acrylate, pentaerythritol tri(meth)acrylate, dipentaerythritol penta(meth)acrylate, ditrimethylolpropane tri(meth)acrylate, allyl alcohol and 2-allyloxy ethanol.

Examples of the monoisocyanate hydroxy compounds used for eliminating the influence of the terminal hydroxyl residue include phenyl isocyanate, hexyl isocyanate and dodecyl isocyanate.

### Carboxyl Group-Containing Polyurethane (A)

The carboxyl group-containing polyurethane (A) preferably has a number-average molecular weight of 1,000 to 200,000, more preferably 2,000 to 60,000. The molecular weight as used herein is a value in terms of polystyrene determined by gel permeation chromatography. Molecular weights less than 1,000 can result in poor elongation, flexibility and strength of the cured film obtained. When the molecular weight exceeds 200,000, the polyurethane (A) can be less soluble in a solvent and can give an excessively viscous solution, and consequently the use can be very limited.

Herein, GPC conditions are as follows unless otherwise mentioned.

Chromatograph: HPLC unit HSS-2000 manufactured by JASCO Corporation

Column: Shodex Column LF-804

Eluent: tetrahydrofuran

Flow rate: 1.0 ml/min

Detector: RI-2031 Plus manufactured by JASCO Corporation

Temperature: 40.0° C.

Sample size: 100 μl placed in a sample loop

Sample concentration: approximately 0.1 wt %

The carboxyl group-containing polyurethane (A) preferably has an acid value of 5 to 120 mgKOH/g, more preferably 10 to 70 mgKOH/g. When the acid value is less than 5 mgKOH/g, the reactivity with other curable resins such as epoxy resins can be lowered and the heat resistance can be often deteriorated. When the acid value exceeds 120 mgKOH/g, the cured film can be too rigid and brittle.

The carboxyl group-containing polyurethane (A) preferably has a number-average molecular weight of 1,000 to 200,000 and an acid value of 5 to 120 mgKOH/g, more preferably have a number-average molecular weight of 2,000 to 60,000 and an acid value of 10 to 70 mgKOH/g.

Herein, the acid value of the resin is a value determined by the following method.

Approximately 0.2 g of a sample is weighed in a 100 ml conical flask using a precision balance, and the sample is dissolved by adding 10 ml of an ethanol/toluene mixed solvent (½ by weight). One to three droplets of phenolphthalein/ethanol solution as an indicator are added to the flask, and the mixture is stirred sufficiently to uniformity. The mixture is titrated with a 0.1N potassium hydroxide/ethanol solution, and the end point of neutralization is obtained when the indicator is slightly red for 30 seconds. The results are put to the following equation to calculate the acid value of the resin.

Acid value (mgKOH/g)=[B×f×5.611]/S

wherein:

B: consumption (ml) of 0.05N potassium hydroxide/ethanol solution

f: factor of 0.05N potassium hydroxide/ethanol solution

S: amount of sample (g)

The carboxyl group-containing polyurethane (A) may be synthesized by reacting the polyisocyanate (a), polyol (b), dihydroxy compound (c), optional monohydroxy compound (d) and optional monoisocyanate compound (e) in the absence or presence of a known urethanization catalyst such as dibutyltin dilaurate, in an appropriate organic solvent. The reaction without the catalyst results in higher properties when the cured film is actually used.

The organic solvent used herein has low reactivity with isocyanates. Desirable solvents are free of basic compounds such as amines and have a boiling point of not less than 110° C., preferably not less than 120° C., more preferably not less than 200° C. Examples of such solvents include toluene, xylene, ethylbenzene, nitrobenzene, cyclohexane, isophorone, diethylene glycol dimethyl ether, ethylene glycol diethyl ether, propylene glycol methyl ether acetate, propylene glycol ethyl ether acetate, dipropylene glycol methyl ether acetate, diethylene glycol ethyl ether acetate, methyl methoxypropionate, ethyl methoxypropionate, methyl ethoxypropionate, ethyl ethoxypropionate, ethyl acetate, n-butyl acetate, isoamyl acetate, ethyl lactate, acetone, methyl ethyl ketone, cyclohexanone, N,N-dimethylformamide, N,N-dimethylacetamide, N-methylpyrrolidone, γ-butyrolactone, dimethylsulfoxide, chloroform and methylene chloride.

Of these, propylene glycol methyl ether acetate, propylene glycol ethyl ether acetate, dipropylene glycol methyl ether acetate, diethylene glycol ethyl ether acetate and γ-butyrolactone are preferable in view of the facts that the organic solvents in which the carboxyl group-containing polyurethane (A) shows low solubility are not preferable and that the polyurethane (A) has an application in electronic materials in which it is used as a material of inks.

The addition sequence of the materials is not particularly limited. Generally, the polyol (b) and dihydroxy compound (c) are fed first and dissolved in the solvent, and the diisocyanate compound (a) is added dropwise at 20 to 150° C., more preferably 60 to 120° C., and these are reacted together at 50 to 160° C., more preferably 60 to 130° C.

The molar ratio of the materials is controlled depending on an objective molecular weight and acid value of the polyurethane. When the monohydroxy compound (d) is introduced in the polyurethane, it is necessary that the diisocyanate compound (a) be used in excess over the polyol (b) and dihydroxy compound (c) (so that the isocyanate groups are excess over the total hydroxyl groups) such that the polyurethane molecule is terminated with the isocyanate groups.

To introduce the monohydroxy compound (d) in the polyurethane, the monohydroxy compound (d) is added dropwise to the solution of the polyurethane at 20 to 150° C., more preferably 70 to 120° C. when the reaction of the polyol (b) and dihydroxy compound (c) with the diisocyanate (a) has substantially terminated, whereby the isocyanate groups remaining at both ends of the polyurethane are reacted with the monohydroxy compound (d); thereafter the temperature is maintained constant to allow the reaction to complete.

To introduce the monoisocyanate compound (e) in the polyurethane, the monoisocyanate compound (e) is added dropwise to the solution of the polyurethane at 20 to 150° C., more preferably 70 to 120° C. when the reaction of the polyol (b) and dihydroxy compound (c) with the diisocyanate (a) has substantially terminated, whereby the hydroxyl groups remaining at both ends of the polyurethane are reacted with the monoisocyanate compound (e); thereafter the temperature is maintained constant to allow the reaction to complete.

### Solution of the Carboxyl Group-Containing Polyurethane

The solution of the carboxyl group-containing polyurethane according to the present invention includes the carboxyl group-containing polyurethane (A) and a solvent, and the carboxyl group-containing polyurethane (A) is dissolved in the solvent.

The organic solvents described above may be favorably used as the solvent herein.

The solution of the carboxyl group-containing polyurethane preferably has a concentration of the carboxyl group-containing polyurethane (A) (solid concentration) of 10 to 90 wt %, more preferably 30 to 80 wt %.

### Heat-Curable Resin Composition

The heat-curable resin composition according to the present invention includes:

(A) 100 parts by mass of a carboxyl group-containing polyurethane resin; and

(B) 1 to 100 parts by mass of an epoxy resin.

Preferably, the heat-curable resin composition further includes a solvent and the carboxyl group-containing polyurethane (A) is dissolved in the solvent.

The organic solvents described above may be favorably used as the solvent herein.

The heat-curable resin composition including the solvent preferably has a concentration of the carboxyl group-containing polyurethane (A) (solid concentration) of 10 to 90 wt %, more preferably 30 to 80 wt %.

The heat-curable resin composition may further include inorganic fine particles and/or organic fine particles (C), and a curing agent (D).

### (B) Epoxy Resin

Examples of the epoxy resins (B) include:

bisphenol A epoxy resins such as EPIKOTE series 828, 1002 and 1004 manufactured by JAPAN EPOXY RESIN CO., LTD.;

bisphenol F epoxy resins such as EPIKOTE series 806, 807 and 4005P manufactured by JAPAN EPOXY RESIN CO., LTD., and YDF-170 manufactured by Tohto Kasei Co., Ltd.;

phenol novolak epoxy resins such as EPIKOTE series 152 and 154 manufactured by JAPAN EPOXY RESIN CO., LTD., EPPN-201 manufactured by NIPPON KAYAKU CO., LTD., and DEN-438 manufactured by The Dow Chemical Company;

o-cresol novolak epoxy resins such as EOCN series 125S, 103S and 104S manufactured by NIPPON KAYAKU CO., LTD.;

biphenyl epoxy resins such as EPIKOTE series YX-4000, YL-6640 and YL-6121H manufactured by JAPAN EPOXY RESIN CO., LTD.;

polyfunctional epoxy resins such as EPIKOTE 1031S manufactured by JAPAN EPOXY RESIN CO., LTD., Araldite 0163 manufactured by Ciba Specialty Chemicals Inc., and DENACOL series EX-611, EX-614, EX-614B, EX-622, EX-512, EX-521, EX-421, E-411 and EX-321 manufactured by Nagase Kasei Kogyo K.K.;

amine epoxy resins such as EPIKOTE 604 manufactured by JAPAN EPOXY RESIN CO., LTD., YH-434 manufactured by Tohto Kasei Co., Ltd., TETRAD-X and TETRAD-C manufactured by MITSUBISHI GAS CHEMICAL COMPANY, INC., GAN manufactured by NIPPON KAYAKU CO., LTD., and ELM-120 manufactured by Sumitomo Chemical Co., Ltd.;

heterocyclic epoxy resins such as Araldite PT810 manufactured by Ciba Specialty Chemicals Inc.; and

alicyclic epoxy resins such as ERL series 4234, 4299, 4221 and 4206 manufactured by UCC and EPOLEAD GT401 manufactured by DAICEL CHEMICAL INDUSTRIES, LTD.

These may be used singly or in combination of two or more kinds.

Of the epoxy resins, the bisphenol A epoxy resins, bisphenol F epoxy resins and biphenyl epoxy resins are more preferable in terms of mechanical properties, adhesion and flexibility. The epoxy equivalent is preferably in the range of 155 to 20,000, more preferably 155 to 1,000.

The amount of the epoxy resin (B) is from 1 to 100 parts by mass, preferably from 5 to 50 parts by mass based on 100 parts by mass of the carboxyl group-containing polyurethane resin (A). Amounts of the epoxy resin (B) less than 1 part by mass can lead to decrease in heat resistance, adhesion and flexibility of the cured product. When the amount exceeds 100 parts by mass, the cured product can show lowered warpage resistance and mechanical strength.

The equivalent ratio of the epoxy groups in the epoxy resin (B) to the carboxyl groups in the carboxyl group-containing polyurethane resin (A) is desirably in the range of 0.2 to 2, preferably 0.5 to 1.5 ([epoxy groups in the epoxy resin (B)]/[carboxyl groups in the polyurethane resin (A)]=0.2 to 2, preferably 0.5 to 1.5). When the ratio is less than 0.2, the heat-curable resin composition can show lower curability. When the ratio is above 2, the storage stability can be deteriorated.

(C) Inorganic Fine Particles and/or Organic Fine Particles

The inorganic fine particles and/or organic fine particles (C) optionally used in the invention are not particularly limited as long as they are capable of dispersing in the carboxyl group-containing polyurethane resin (A), a solution thereof, the epoxy resin (B) or a solution thereof to give a paste.

Examples of the inorganic fine particles include silica (SiO₂), alumina (Al₂O₃), titania (TiO₂), tantalum oxide (Ta₂O₅), zirconia (ZrO₂), silicon nitride (Si₃N₄), barium titanate (BaO.TiO₂), barium carbonate (BaCO₃), lead titanate (PbO.TiO₂), lead zirconate titanate (PZT), lead lanthanum zirconate titanate (PLZT), gallium oxide (Ga₂O₃), spinel (MgO.Al₂O₃), mullite (3Al₂O₃.2SiO₂), cordierite (2MgO.2Al₂O₃.5SiO₂), talc (3MgO.4SiO₂.H₂O), aluminum titanate (TiO₂—Al₂O₃), yttria-containing zirconia (Y₂O₃—ZrO₂), barium silicate (BaO.8SiO₂), boron nitride (BN), calcium carbonate (CaCO₃), calcium sulfate (CaSO₄), zinc oxide (ZnO), magnesium titanate (MgO.TiO₂), barium sulfate (BaSO₄), organic bentonite and carbon (C). These may be used singly or in combination of two or more kinds.

The organic fine particles are not particularly limited as long as they are capable of dispersing in the carboxyl group-containing polyurethane resin (A), a solution thereof, the epoxy resin (B) or a solution thereof to give a paste.

Preferred organic fine particles include fine particles of heat resistant resins having amide bonds, imide bonds, ester bonds or ether bonds. Examples of the resins suitable in terms of heat resistance and mechanical properties include polyimide resins, precursors thereof, polyamideimide resins, precursors thereof, and polyamide resins.

The average particle diameter of the inorganic and/or organic fine particles (C) are preferably in the range of 0.01 to 10 μm, more preferably 0.1 to 5 μm.

The amount of the inorganic and/or organic fine particles (C) is from 1 to 100 parts by mass, preferably 1 to 30 parts by mass based on 100 parts by mass of the aforesaid heat-curable resin composition.

### (D) Curing Agent

The invention may optionally use a curing agent (D) to improve properties such as adhesion, chemical resistance and heat resistance of the cured product.

Examples of the curing agents (D) include known curing agents and curing accelerators, for example:

imidazole derivatives such as CUREZOL series 2MZ, 2E4MZ, C₁₁Z, C₁₇Z, 2PZ, 1B2MZ, 2MZ-CN, 2E4MZ-CN, C₁₁Z-CN, 2PZ-CN, 2PHZ-CN, 2MZ-CNS, 2E4MZ-CNS, 2PZ-CNS, 2MZ-AZINE, 2E4MZ-AZINE, C₁₁Z-AZINE, 2MA-OK, 2P4 MHZ, 2PHZ and 2P4BHZ manufactured by SHIKOKU CHEMICALS CORPORATION;

guanamines such as acetoguanamine and benzoguanamine;

polyamines such as diaminodiphenylmethane, m-phenylenediamine, m-xylenediamine, diaminodiphenylsulfone, dicyandiamide, urea, urea derivatives, melamine and polybasic hydrazide;

organic acid salts and/or epoxy adducts thereof;

amine complexes of boron trifluoride;

triazine derivatives such as ethyldiamino-S-triazine, 2,4-diamino-S-triazine and 2,4-diamino-6-xylyl-S-triazine;

amines such as trimethylamine, triethanolamine, N,N-dimethyloctylamine, N-benzyldimethylamine, pyridine, N-methylmorpholine, hexa(n-methyl)melamine, 2,4,6-tris(dimethylaminophenol), tetramethylguanidine and m-aminophenol;

polyphenols such as polyvinylphenol, polyvinylphenol bromide, phenol novolak and alkylphenol novolaks;

organic phosphines such as tributylphosphine, triphenylphosphine and tris-2-cyanoethylphosphine;

phosphonium salts such as tri-n-butyl(2,5-dihydroxyphenyl)phosphonium bromide and hexadecyltributylphosphonium chloride;

quaternary ammonium salts such as benzyltrimethylammonium chloride and phenyltributylammonium chloride;

anhydrides of the polybasic acids mentioned above;

photo-cationic polymerization catalysts such as diphenyl iodonium tetrafluoroborate, triphenyl sulfonium hexafluoroantimonate, 2,4,6-triphenyl thiopyrilium hexafluorophosphate, IRGACURE 261 manufactured by Ciba Specialty Chemicals Inc., and Optomer SP-170 manufactured by Asahi Denka Co., Ltd.;

styrene-maleic anhydride resin; and

equimolar reaction products of phenyl isocyanate and dimethylamine, and equimolar reaction products of dimethylamine and organic polyisocyanates such as tolylene diisocyanate and isophorone diisocyanate.

The curing agent (D) should be selected appropriately depending on the types of the polyurethane resin (A) and the epoxy resin (B) that are cured.

The curing agents (D) may be used singly or in combination of two or more kinds.

The amount of the curing agent (D) is preferably from 0.1 to 25 parts by mass, more preferably from 0.5 to 15 parts by mass based on 100 parts by mass of the carboxyl group-containing polyurethane resin (A) and the epoxy resin (B) combined. Amounts of the curing agent (D) less than 0.1 part by mass can result in inadequate curing of the heat-curable resin composition. When the amount exceeds 25 parts by mass, the cured product can contain much sublimative components.

### Coating Paste

The coating paste of the invention includes the heat-curable resin composition and a nitrogen-free polar solvent.

The heat-curable resin composition may be dissolved or dispersed in an appropriate organic solvent to give a paste for coating.

The organic solvent is preferably a nitrogen-free polar solvent. Examples of such solvents include:

ether solvents such as diethylene glycol dimethyl ether, diethylene glycol diethyl ether, triethylene glycol dimethyl ether and triethylene glycol diethyl ether;

sulfur-containing solvents such as dimethyl sulfoxide, diethyl sulfoxide, dimethyl sulfone and sulfolane;

ester solvents such as γ-butyrolactone, diethylene glycol monomethyl ether acetate, ethylene glycol monomethyl ether acetate, propylene glycol monomethyl ether acetate, diethylene glycol monoethyl ether acetate, ethylene glycol monoethyl ether acetate and propylene glycol monoethyl ether acetate;

ketone solvents such as cyclohexanone and methyl ethyl ketone;

aromatic hydrocarbon solvents such as toluene and xylene; and

petroleum naphtha.

These solvents may be used singly or in combination of two or more kinds.

Particularly, γ-butyrolactone, diethylene glycol monomethyl ether acetate, ethylene glycol monomethyl ether acetate, propylene glycol monomethyl ether acetate, diethylene glycol monoethyl ether acetate, ethylene glycol monoethyl ether acetate and propylene glycol monoethyl ether acetate are preferable because they are highly volatile and permit curing to take place at low temperatures. The solvent used in the synthesis of the carboxyl group-containing polyurethane resin (A) may be continuously used herein.

### Other Components

The heat-curable resin composition and paste thereof may contain other components for improving workability in the application, and for improving film-forming properties and properties of films produced. Such components include surfactants such as anti-foaming agents and leveling agents, coloring agents such as dyes and pigments, curing accelerators, heat stabilizers, antioxidants, flame-retardants and lubricating agents.

### EXAMPLES

The present invention will be described by the following examples, but it should be construed that the invention is not limited to the examples.

### Example a1

A reaction vessel equipped with a stirrer, a thermometer and a condenser was charged with 1172 g of polymer polyol polybutadiene having 1,2-repeating units (G-1000 manufactured by NIPPON SODA CO., LTD.), 184.5 g of carboxyl group-containing dihydroxy compound 2,2-dimethylolbutanoic acid (manufactured by Nippon Kasei Chemical Co., Ltd.) and 1744 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 125 g (0.48 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 3 hours, 90° C. for 3 hours, and 100° C. for 3 hours. When the substantial disappearance of the isocyanate was confirmed, 4.4 g (0.06 mol) of isobutanol (manufactured by Wako Pure Chemical Industries, Ltd.) was added dropwise and reaction was performed at 100° C. for 1.5 hours.

The carboxyl group-containing polyurethane resin obtained had a number-average molecular weight of 7,800 and an acid value of the solid of 35.0 mgKOH/g.

### Example a2

A reaction vessel equipped with a stirrer, a thermometer and a condenser was charged with 73.9 g of polymer polyol polybutadiene having 1,2-repeating units (G-1000 manufactured by NIPPON SODA CO., LTD.), 12.0 g of carboxyl group-containing dihydroxy compound 2,2-dimethylolpropionic acid (manufactured by Nippon Kasei Chemical Co., Ltd.) and 125.1 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 36.0 g (0.137 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 2.0 g (0.027 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 8,000 and an acid value of the solid of 40.1 mgKOH/g.

### Example a3

A reaction vessel equipped with a stirrer, a thermometer and a condenser was charged with 89.8 g of polymer polyol polybutadiene having 1,2-repeating units (G-1000 manufactured by NIPPON SODA CO., LTD.), 6.61 g of carboxyl group-containing dihydroxy compound 2,2-dimethylolbutanoic acid (manufactured by Nippon Kasei Chemical Co., Ltd.) and 125.0 g of propylene glycol methyl ether acetate as solvent (manufactured by DAICEL CHEMICAL INDUSTRIES, LTD.). The materials were dissolved at 90° C. The temperature of the reaction liquid was lowered to 70° C., and 27.0 g (0.103 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 1.5 g (0.021 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 7,900 and an acid value of the solid of 20.1 mgKOH/g.

### Example a4

A reaction vessel equipped with a stirrer, a thermometer and a condenser was charged with 41.8 g of polymer polyol polybutadiene having 1,2-repeating units (G-1000 manufactured by NIPPON SODA CO., LTD.), 26.4 g of carboxyl group-containing dihydroxy compound 2,2-dimethylolbutanoic acid (manufactured by Nippon Kasei Chemical Co., Ltd.) and 125.1 g of γ-butyrolactone as solvent (manufactured by Tokyo Chemical Industry Co., Ltd.). The materials were dissolved at 90° C. The temperature of the reaction liquid was lowered to 70° C., and 53.9 g (0.205 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 3.0 g (0.041 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 7,600 and an acid value of the solid of 60.3 mgKOH/g.

### Example a5

A reaction vessel equipped with a stirrer, a thermometer and a condenser was charged with 48.5 g of polymer polyol polybutadiene having 1,2-repeating units (G-1000 manufactured by NIPPON SODA CO., LTD.), 31.7 g of polymer polyol polycarbonate diol (UC-CARB 100 manufactured by UBE INDUSTRIES, LTD.), 13.2 g (0.089 mol) of carboxyl group-containing dihydroxy compound 2,2-dimethylolbutanoic acid and 125.1 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 29.6 g (0.152 mol) of polyisocyanate TAKENATE 600 (manufactured by MITSUI TAKEDA CHEMICALS, INC.) was added dropwise over a period of 15 minutes. Reaction was performed at 80° C. for 1 hour, 90° C. for 1 hour, and 100° C. for 1.5 hours. When the substantial disappearance of the isocyanate was confirmed, 2.3 g (0.030 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 8,600 and an acid value of the solid of 40.9 mgKOH/g.

### Example a6

A reaction vessel equipped with a stirrer, a thermometer and a condenser was charged with 62.1 g of polymer polyol polybutadiene having 1,2-repeating units (G-1000 manufactured by NIPPON SODA CO., LTD.), 18.3 g of polymer polyol polycarbonate diol (UM-CARB 90 (3/1) manufactured by UBE INDUSTRIES, LTD.), 13.2 g (0.089 mol) of carboxyl group-containing dihydroxy compound 2,2-dimethylolbutanoic acid and 125.0 g of diethylene glycol ethyl ether acetate as solvent. The materials were dissolved at 90° C. The temperature of the reaction liquid was lowered to 80° C., and 29.1 g (0.15 mol) of polyisocyanate TAKENATE 600 (manufactured by MITSUI TAKEDA CHEMICALS, INC.) was added dropwise with a dropping funnel over a period of 30 minutes. After the completion of the dropwise addition, reaction was performed at 80° C. for 2 hours, 90° C. for 1 hour, and 100° C. for 1.5 hours. When the substantial disappearance of the isocyanate was confirmed, 2.2 g (0.030 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 12,000 and an acid value of the solid of 40.2 mgKOH/g.

### Example a7

A reaction vessel equipped with a stirrer, a thermometer and a condenser was charged with 50.4 g of polymer polyol polybutadiene having 1,2-repeating units (G-1000 manufactured by NIPPON SODA CO., LTD.), 32.3 g of polymer polyol polycarbonate diol (UM-CARB 90 (1/1) manufactured by UBE INDUSTRIES, LTD.), 13.2 g (0.089 mol) of carboxyl group-containing dihydroxy compound 2,2-dimethylolbutanoic acid and 125.0 g of diethylene glycol ethyl ether acetate as solvent. The materials were dissolved at 90° C. The temperature of the reaction liquid was lowered to 80° C., and 30.0 g (0.15 mol) of polyisocyanate TAKENATE 600 (manufactured by MITSUI TAKEDA CHEMICALS, INC.) was added dropwise with a dropping funnel over a period of 30 minutes. After the completion of the dropwise addition, reaction was performed at 80° C. for 2 hours, 90° C. for 1 hour, and 100° C. for 1.5 hours. When the substantial disappearance of the isocyanate was confirmed, 2.3 g (0.030 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 9,800 and an acid value of the solid of 39.8 mgKOH/g.

### Example a8

A reaction vessel equipped with a stirrer, a thermometer and a condenser was charged with 83.6 g of polymer polyol polybutadiene having 1,2-repeating units (G-2000 manufactured by NIPPON SODA CO., LTD.), 13.2 g (0.089 mol) of carboxyl group-containing dihydroxy compound 2,2-dimethylolbutanoic acid and 125.0 g of diethylene glycol ethyl ether acetate as solvent. The materials were dissolved at 90° C. The temperature of the reaction liquid was lowered to 80° C., and 26.3 g (0.13 mol) of polyisocyanate norbornene diisocyanate (COSMONATE NBDI manufactured by MITSUI TAKEDA CHEMICALS, INC.) was added dropwise with a dropping funnel over a period of 30 minutes. After the completion of the dropwise addition, reaction was performed at 80° C. for 2 hours, 90° C. for 1 hour, and 100° C. for 1.5 hours. When the substantial disappearance of the isocyanate was confirmed, 1.9 g (0.026 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 7,600 and an acid value of the solid of 41.2 mgKOH/g.

### Example a9

A reaction vessel equipped with a stirrer, a thermometer and a condenser was charged with 85.1 g of polymer polyol polybutadiene having 1,2-repeating units (G-3000 manufactured by NIPPON SODA CO., LTD.), 13.2 g (0.089 mol) of carboxyl group-containing dihydroxy compound 2,2-dimethylolbutanoic acid and 125.0 g of diethylene glycol ethyl ether acetate as solvent. The materials were dissolved at 90° C. The temperature of the reaction liquid was lowered to 80° C., and 25.3 g (0.11 mol) of polyisocyanate isophorone diisocyanate (DESMODUR I manufactured by Sumika Bayer Urethane Co., Ltd.) was added dropwise with a dropping funnel over a period of 1 hour. After the completion of the dropwise addition, reaction was performed at 80° C. for 1 hour, 90° C. for 1 hour, and 100° C. for 2 hours. When the substantial disappearance of the isocyanate was confirmed, 1.7 g (0.023 mol) of isobutanol (manufactured by Wako Pure Chemical Industries, Ltd.) was added dropwise and reaction was performed at 100° C. for 1 hour.

The carboxyl group-containing polyurethane resin obtained had a number-average molecular weight of 8,400 and an acid value of the solid of 39.8 mgKOH/g.

### Example a10

A reaction vessel equipped with a stirrer, a thermometer and a condenser was charged with 52.9 g of polymer polyol G-1000 (polybutadiene having 1,2-repeating units, manufactured by NIPPON SODA CO., LTD.), 23.6 g of carboxyl group-containing dihydroxy compound 2,2-dimethylolbutanoic acid (manufactured by Nippon Kasei Chemical Co., Ltd.) and 127.6 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 50.6 g (0.19 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 2 hours, and 100° C. for 1 hour. When the substantial disappearance of the isocyanate was confirmed, 1.72 g (0.023 mol) of isobutanol (manufactured by Wako Pure Chemical Industries, Ltd.) was added dropwise and reaction was performed at 100° C. for 1.5 hours.

The carboxyl group-containing polyurethane obtained had a number-average molecular weight of 12, 600 and an acid value of the solid of 69.3 mgKOH/g.

### Example a11

A reaction vessel equipped with a stirrer, a thermometer and a condenser was charged with 29.8 g of polymer polyol G-1000 (polybutadiene having 1,2-repeating units, manufactured by NIPPON SODA CO., LTD.), 34.4 g of carboxyl group-containing dihydroxy compound 2,2-dimethylolbutanoic acid (manufactured by Nippon Kasei Chemical Co., Ltd.) and 130.0 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 65.6 g (0.25 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 2 hours, 90° C. for 2 hours, and 100° C. for 1 hour. When the substantial disappearance of the isocyanate was confirmed, 1.66 g (0.022 mol) of isobutanol (manufactured by Wako Pure Chemical Industries, Ltd.) was added dropwise and reaction was performed at 100° C. for 1.5 hours.

The carboxyl group-containing polyurethane obtained had a number-average molecular weight of 15, 800 and an acid value of the solid of 98.9 mgKOH/g.

### Example a12

A reaction vessel equipped with a stirrer, a thermometer and a condenser was charged with 153.7 g of polymer polyol G-1000 (polybutadiene having 1,2-repeating units, manufactured by NIPPON SODA CO., LTD.), 153.7 g of polymer polyol PTXG-1000 (manufactured by ASAHI KASEI FIBERS CORPORATION), 222.5 g of carboxyl group-containing dihydroxy compound 2,2-dimethylolbutanoic acid (manufactured by Nippon Kasei Chemical Co., Ltd.) and 1054.5 g of propylene glycol methyl ether acetate as solvent (manufactured by DAICEL CHEMICAL INDUSTRIES, LTD.). The materials were dissolved at 90° C. The temperature of the reaction liquid was lowered to 70° C., and 348.3 g (2.0 mol) of polyisocyanate COSMONATE T-80 (manufactured by MITSUI TAKEDA CHEMICALS, INC.) was added dropwise with a dropping funnel over a period of 1 hour. After the completion of the dropwise addition, reaction was performed at 80° C. for 3 hours, 90° C. for 3 hours, and 100° C. for 3 hours. When the substantial disappearance of the isocyanate was confirmed, a mixture consisting of 58.5 g (0.79 mol) of 2-hydroxyethyl acrylate (manufactured by OSAKA ORGANIC CHEMICAL INDUSTRY LTD.) and 0.444 g of polymerization inhibitor IRGANOX 1010 (manufactured by Ciba Specialty Chemicals Inc.) was added dropwise and reaction was performed at 100° C. for 1.5 hours.

The carboxyl group-containing polyurethane obtained had a number-average molecular weight of 3,600 and an acid value of the solid of 90.0 mgKOH/g.

### Example a13

A reaction vessel equipped with a stirrer, a thermometer and a condenser was charged with 31.3 g of polymer polyol G-1000 (polybutadiene having 1,2-repeating units, manufactured by NIPPON SODA CO., LTD.), 47.2 g of polymer polyol PTXG-1800 (manufactured by ASAHI KASEI FIBERS CORPORATION), 60.5 g of carboxyl group-containing dihydroxy compound 2,2-dimethylolbutanoic acid (manufactured by Nippon Kasei Chemical Co., Ltd.) and 254.8 g of propylene glycol methyl ether acetate as solvent (manufactured by DAICEL CHEMICAL INDUSTRIES, LTD.). The materials were dissolved at 90° C. The temperature of the reaction liquid was lowered to 70° C., and 101.5 g (0.52 mol) of polyisocyanate TAKENATE 600 (manufactured by MITSUI TAKEDA CHEMICALS, INC.) was added dropwise with a dropping funnel over a period of 1 hour. After the completion of the dropwise addition, reaction was performed at 80° C. for 1 hour, 90° C. for 1 hour, and 100° C. for 1.5 hours. When the substantial disappearance of the isocyanate was confirmed, a mixture consisting of 15.8 g (0.21 mol) of 2-hydroxyethyl acrylate (manufactured by OSAKA ORGANIC CHEMICAL INDUSTRY LTD.) and 0.123 g of polymerization inhibitor IRGANOX 1010 (manufactured by Ciba Specialty Chemicals Inc.) was added dropwise and reaction was performed at 100° C. for 1.5 hours.

The carboxyl group-containing polyurethane obtained had a number-average molecular weight of 5,000 and an acid value of the solid of 89.4 mgKOH/g.

### Example a14

A reaction vessel equipped with a stirrer, a thermometer and a condenser was charged with 132.4 g of polymer polyol G-1000 (polybutadiene having 1,2-repeating units, manufactured by NIPPON SODA CO., LTD.), 5.04 g of carboxyl group-containing dihydroxy compound 2,2-dimethylolbutanoic acid (manufactured by Nippon Kasei Chemical Co., Ltd.) and 167.8 g of propylene glycol methyl ether acetate as solvent (manufactured by DAICEL CHEMICAL INDUSTRIES, LTD.). The materials were dissolved at 90° C. The temperature of the reaction liquid was lowered to 70° C., and 27.2 g (0.14 mol) of polyisocyanate TAKENATE 600 (manufactured by MITSUI TAKEDA CHEMICALS, INC.) was added dropwise with a dropping funnel over a period of 1 hour. After the completion of the dropwise addition, reaction was performed at 80° C. for 1 hour, 90° C. for 1 hour, and 100° C. for 1.5 hours. When the substantial disappearance of the isocyanate was confirmed, a mixture consisting of 3.25 g (0.028 mol) of 2-hydroxyethyl acrylate (manufactured by OSAKA ORGANIC CHEMICAL INDUSTRY LTD.) and 0.121 g of polymerization inhibitor IRGANOX 1010 (manufactured by Ciba Specialty Chemicals Inc.) was added dropwise and reaction was performed at 100° C. for 1.5 hours.

The carboxyl group-containing polyurethane obtained had a number-average molecular weight of 8,400 and an acid value of the solid of 20.3 mgKOH/g.

### Example a15

A reaction vessel equipped with a stirrer, a thermometer and a condenser was charged with 92.3 g of polymer polyol G-1000 (polybutadiene having 1,2-repeating units, manufactured by NIPPON SODA CO., LTD.), 14.8 g of carboxyl group-containing dihydroxy compound 2,2-dimethylolbutanoic acid (manufactured by Nippon Kasei Chemical Co., Ltd.) and 108.6 g of diethylene glycol ethyl ether acetate as solvent (manufactured by DAICEL CHEMICAL INDUSTRIES, LTD.). The materials were dissolved at 90° C. The temperature of the reaction liquid was lowered to 70° C., and 35.0 g (0.18 mol) of polyisocyanate TAKENATE 600 (manufactured by MITSUI TAKEDA CHEMICALS, INC.) was added dropwise with a dropping funnel over a period of 1 hour. After the completion of the dropwise addition, reaction was performed at 80° C. for 1 hour, 90° C. for 1 hour, and 100° C. for 1.5 hours. When the substantial disappearance of the isocyanate was confirmed, a mixture consisting of 5.6 g (0.036 mol) of KARENZ MOI (2-methacryloyloxyethyl isocyanate, manufactured by SHOWA DENKO K.K.) and 0.053 g of polymerization inhibitor IRGANOX 1010 (manufactured by Ciba Specialty Chemicals Inc.) was added dropwise and reaction was performed at 100° C. for 1.5 hours.

The carboxyl group-containing polyurethane obtained had a number-average molecular weight of 7,100 and an acid value of the solid of 38.0 mgKOH/g.

### Example a16

A reaction vessel equipped with a stirrer, a thermometer and a condenser was charged with 68.8 g of polymer polyol EPOL (manufactured by Idemitsu Kosan Co., Ltd.), 11.7 g of carboxyl group-containing dihydroxy compound 2,2-dimethylolbutanoic acid (manufactured by Nippon Kasei Chemical Co., Ltd.) and 147.7 g of a solvent (product of DAICEL CHEMICAL INDUSTRIES, LTD.). The materials were dissolved at 90° C. The temperature of the reaction liquid was lowered to 70° C., and 28.4 g (0.11 mol) of polyisocyanate DESMODUR W (manufactured by Sumika Bayer Urethane Co., Ltd.) was added dropwise with a dropping funnel over a period of 1 hour. After the completion of the dropwise addition, reaction was performed at 80° C. for 1 hour, 90° C. for 1 hour, and 100° C. for 1.5 hours. When the substantial disappearance of the isocyanate was confirmed, 1.64 g (0.022 mol) of isobutanol (manufactured by Wako Pure Chemical Industries, Ltd.) was added dropwise and reaction was performed at 100° C. for 1 hour.

The carboxyl group-containing polyurethane obtained had a number-average molecular weight of 12,300 and an acid value of the solid of 40.1 mgKOH/g.

### Comparative Example a1

A reaction vessel equipped with a stirrer, a thermometer and a condenser was charged with 56.1 g of polymer polyol Kuraray Polyol C-1090 (manufactured by KURARAY CO., LTD.), 10.4 g (0.070 mol) of carboxyl group-containing dihydroxy compound 2,2-dimethylolbutanoic acid and 100.0 g of diethylene glycol ethyl ether acetate as solvent. The materials were dissolved at 90° C. 33.6 g (0.13 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 2.4 g (0.032 mol) of isobutanol (manufactured by Wako Pure Chemical Industries, Ltd.) was added dropwise and reaction was performed at 100° C. for 30 minutes.

The carboxyl group-containing polyurethane resin obtained had a number-average molecular weight of 9,500 and an acid value of the solid of 40.0 mgKOH/g.

### Comparative Example a2

A reaction vessel equipped with a stirrer, a thermometer and a condenser was charged with 38.7 g of polymer polyol polycarbonate diol (UC-CARB 100 manufactured by UBE INDUSTRIES, LTD.), 18.5 g (0.125 mol) of carboxyl group-containing dihydroxy compound 2,2-dimethylolbutanoic acid and 102.5 g of diethylene glycol ethyl ether acetate as solvent. The materials were dissolved at 90° C. 42.9 g (0.16 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 2.5 g (0.034 mol) of isobutanol (manufactured by Wako Pure Chemical Industries, Ltd.) was added dropwise and reaction was performed at 100° C. for 30 minutes.

The carboxyl group-containing polyurethane resin obtained had a number-average molecular weight of 12,600 and an acid value of the solid of 68.3 mgKOH/g.

### Comparative Example a3

A reaction vessel equipped with a stirrer, a thermometer and a condenser was charged with 65.5 g of polymer polyol PTXG-1800 (manufactured by ASAHI KASEI FIBERS CORPORATION), 11.3 g (0.076 mol) of carboxyl group-containing dihydroxy compound 2,2-dimethylolbutanoic acid and 106.3 g of diethylene glycol ethyl ether acetate as solvent. The materials were dissolved at 90° C. 29.3 g (0.11 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1 hour. When the substantial disappearance of the isocyanate was confirmed, 1.7 g (0.023 mol) of isobutanol (manufactured by Wako Pure Chemical Industries, Ltd.) was added dropwise and reaction was performed at 100° C. for 1.5 hours.

The carboxyl group-containing polyurethane resin obtained had a number-average molecular weight of 9,000 and an acid value of the solid of 39.7 mgKOH/g.

### Comparative Example a4

A reaction vessel equipped with a stirrer, a thermometer and a condenser was charged with 62.5 g of polymer polyol Kuraray Polyol P-2030 (manufactured by KURARAY CO., LTD.), 10.4 g (0.070 mol) of carboxyl group-containing dihydroxy compound 2,2-dimethylolbutanoic acid and 101.5 g of diethylene glycol ethyl ether acetate as solvent. The materials were dissolved at 90° C. 26.8 g (0.10 mol) of polyisocyanate DESMODUR W (manufactured by Sumika Bayer Urethane Co., Ltd.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 1.5 g (0.021 mol) of isobutanol (manufactured by Wako Pure Chemical Industries, Ltd.) was added dropwise and reaction was performed at 100° C. for 30 minutes.

The carboxyl group-containing polyurethane resin obtained had a number-average molecular weight of 10,400 and an acid value of the solid of 40.3 mgKOH/g.

### Comparative Example a5

A reaction vessel equipped with a stirrer, a thermometer and a condenser was charged with 59.9 g of polymer polyol PCDL T5651 (manufactured by Asahi Kasei Chemicals Corporation), 50.5 g (0.34 mol) of carboxyl group-containing dihydroxy compound 2,2-dimethylolbutanoic acid and 209.0 g of propylene glycol methyl ether acetate as solvent. The materials were dissolved at 90° C. 87.4 g (0.45 mol) of polyisocyanate TAKENATE 600 (manufactured by MITSUI TAKEDA CHEMICALS, INC.) was added dropwise with a dropping funnel over a period of 30 minutes. After the completion of the dropwise addition, reaction was performed at 80° C. for 1 hour, 90° C. for 1 hour, and 100° C. for 1.5 hours. When the substantial disappearance of the isocyanate was confirmed, 11.6 g (0.10 mol) of 2-hydroxyethyl acrylate (manufactured by OSAKA ORGANIC CHEMICAL INDUSTRY LTD.) was added dropwise and reaction was performed at 100° C. for 30 minutes.

The carboxyl group-containing polyurethane resin obtained had a number-average molecular weight of 10,400 and an acid value of the solid of 40.3 mgKOH/g.

### [Evaluation of Resist Compositions]

### <Preparation of Solder Resist Inks>

### Example b1

A composition contained 100 parts by mass of the carboxyl group-containing polyurethane resin obtained in Example a1, 6.5 parts by mass of epoxy resin EPIKOTE 828, 2.5 parts by mass of AEROSIL 380, and 1 part by mass of melamine, as set forth in Table 1. The composition was kneaded by being passed through a three-roll mill (RIII-1 RM-2 manufactured by Kodaira Seisakusho Co., Ltd.) three times. Consequently, a solder resist ink was prepared.

### Examples b2-13 and Comparative Examples b1-8

Solder resist inks were prepared in the same manner as in Example b1 with compositions as shown in Tables 1 and 3.

### <Evaluation of Cured Products>

The solder resist inks were cured and evaluated for adhesion, warpage, flexibility, plating resistance, soldering heat resistance and long-term reliability as described below. The results are shown in Tables 2 and 4.

### [Adhesion]

The solder resist ink was applied on a 75 μm thick polyimide film (KAPTON® 300H, manufactured by DUPONT-TORAY CO., LTD.) by screen printing through a No. 100-mesh polyester plate. The printed film was dried at 80° C. for 30 minutes, and the ink was cured at 150° C. for 1 hour. The film with the heat-cured ink was subjected to a cross-cut test according to JIS K 5600.

### [Warpage]

The solder resist ink was applied on a 25 μm thick polyimide film (KAPTON® 300H, manufactured by DUPONT-TORAY CO., LTD.) by screen printing through a No. 100-mesh polyester plate. The printed film was dried at 80° C. for 30 minutes, and the ink was cured at 150° C. for 1 hour. The film with the heat-cured ink was cut to a circle 50 mm in diameter. The circle film was placed with the printed surface upside and was evaluated based on the following criteria.

AA: Maximum warp was less than 5 mm high.

CC: Maximum warp was not less than 5 mm high.

### [Flexibility]

The solder resist ink was applied on a substrate by screen printing through a No. 100-mesh polyester plate. The ink was dried at 80° C. for 30 minutes, and cured at 150° C. for 1 hour. The substrate used was a 25 μm thick polyimide film (KAPTON® 100H, manufactured by DUPONT-TORAY CO., LTD.). The polyimide film with the heat-cured solder resist ink was bent 180° with the coated surface outward, and the occurrence of blushing in the cured film was checked. The flexibility was evaluated based on the following criteria.

AA: No blushing occurred in the cured film.

CC: Blushing or cracks occurred in the cured film.

### [Plating Resistance]

A printed board (UPICEL® N manufactured by UBE INDUSTRIES, LTD.) consisted of a polyimide film (50 μm thick) and a copper foil (35 μm thick) on one surface of the polyimide film. The printed board was washed with acid degreasing agent AC-401 and rinsed with water, followed by drying at 70° C. for 3 minutes. The solder resist ink was applied on the board by screen printing through a No. 100-mesh polyester plate. The ink was dried at 80° C. for 30 minutes, and cured at 150° C. for 1 hour, followed by rinsing with water. The board was soaked in acid degreasing agent ICP Clean 91 at 23° C. for 1 minute, rinsed with water, soaked in a 10% aqueous sulfuric acid solution at 23° C. for 1 minute, and rinsed with water. Thereafter, the board was soaked in a tin plating solution (TINPOSIT LT-34, manufactured by Rohm and Hass Company) at 70° C. for 3 minutes, rinsed with water, and soaked in warm water at 70° C. for 3 minutes. The plated board was heat treated at 120° C. for 2 hours, and the cured film was visually observed. The plating resistance was evaluated based on the following criteria.

AA: The cured film did not change color, and the plating solution did not intrude under the cured film.

CC: The cured film changed color, or the plating solution intruded under the cured film.

### [Soldering Heat Resistance]

The solder resist ink was applied on a substrate by screen printing through a No. 100-mesh polyester plate in accordance with the testing method of JIS C 6481. The ink was dried at 80° C. for 30 minutes, and cured at 150° C. for 1 hour. The substrate used was a printed board (UPICEL® N manufactured by UBE INDUSTRIES, LTD.) consisting of a polyimide film (50 μm thick) and a copper foil (35 μm thick) on one surface of the polyimide film. This substrate had been washed with a 1% aqueous sulfuric acid solution, rinsed with water and air dried. The substrate with the heat-cured solder resist composition was floated in a 260° C. solder bath for 10 seconds, and the cured film was visually observed. The soldering heat resistance was evaluated based on the following criteria.

AA: The cured film did not swell, and the solder did not intrude under the cured film.

CC: The cured film swelled, or the solder intruded under the cured film.

### [Long-Term Reliability]

Flexible copper-clad laminate (UPICEL® N BE1310 manufactured by UBE INDUSTRIES, LTD.) was etched with No. 200-mesh stainless steel screen to a comb-shaped board (the width of the copper wiring/the pitch of the copper wirings=50 μm/50 μm). The solder resist ink was applied on the board by screen printing through a No. 100-mesh polyester plate. The ink was dried at 80° C. for 30 minutes, and cured at 150° C. for 1 hour. The substrate was exposed to 85° C. and 85% RH, and a bias voltage of 100 V was applied to the substrate for 500 hours. The electrical insulating properties were evaluated based on the following criteria.

AA: No migration and no decrease in insulation resistance resulted.

CC: Migration or decreased insulation resistance resulted.

TABLE 1
Composition of curable compositions (parts by mass)

| Polyurethane resin with polybutadiene | Solid Concn. | Acid value of | Ex. | Ex. | Ex. | Ex. | Ex. | Ex. | Ex. |
|---|---|---|---|---|---|---|---|---|---|
| skeleton (A) | (mass %) | solid (mgKOH/g) | b1 | b2 | b3 | b4 | b5 | b6 | b7 |
| (Ex. a1) | 46 | 35 | 100 | | | | | | |
| (Ex. a2) | 50 | 40 | | 100 | | | | | |
| (Ex. a3) | 50 | 20 | | | 100 | | | | |
| (Ex. a4) | 50 | 60 | | | | 100 | | | |
| (Ex. a5) | 50 | 41 | | | | | 100 | | |
| (Ex. a6) | 50 | 40 | | | | | | 100 | |
| (Ex. a7) | 51 | 40 | | | | | | | 100 |
| (Ex. a8) | 50 | 41 | | | | | | | |
| (Ex. a9) | 50 | 40 | | | | | | | |
| (Ex. a10) | 51 | 40 | | | | | | | |
| (Ex. a11) | 50 | 68 | | | | | | | |
| (Ex. a12) | 50 | 40 | | | | | | | |
| (Ex. a13) | 50 | 40 | | | | | | | |
| (Ex. a14) | 50 | 40 | | | | | | | |
| Polycarboxylic acid resin | | | | | | | | | |
| ZFR-1401H¹⁾ | 62 | 101 | | | | | | | |
| CYCLOMER P ACA-250²⁾ | 50 | 70 | | | | | | | |
| | Solid Concn. | Epoxy equivalent | | | | | | | |
| Epoxy resin (B) | (mass %) | (g/eq) | | | | | | | |
| EPIKOTE 828³⁾ | 100 | 189 | 6.5 | | | | | | |
| EPIKOTE 1002⁴⁾ | 100 | 650 | | 27 | | | | | |
| EPIKOTE 807⁵⁾ | 100 | 168 | | | 3.5 | | | | |
| EPIKOTE 8034⁶⁾ | 100 | 290 | | | | 18 | | | |
| EPIKOTE YL7175-500⁷⁾ | 100 | 453 | | | | | 20 | | |
| EPIKOTE YL-6121H⁸⁾ | 100 | 175 | | | | | | 7.5 | |
| EPOTOHTO YDF-8170C⁹⁾ | 100 | 158 | | | | | | | 7 |
| EPOTOHTO YH-434C¹⁰⁾ | 100 | 120 | | | | | | | |
| EPOLEAD GT401¹¹⁾ | 100 | 221 | | | | | | | |
| Inorganic and/or organic fine particles (C) | | | | | | | | | |
| AEROSIL 380¹²⁾ | | | 2.5 | 2.5 | 2.5 | 2.5 | 2.5 | 2.5 | 2.5 |
| Curing agent (D) | | | | | | | | | |
| Melamine | | | 1 | 1 | 1 | 1 | 1 | 1 | 1 |

| Polyurethane resin with polybutadiene | Solid Concn. | Acid value of | Ex. | Ex. | Ex. | | | |
|---|---|---|---|---|---|---|---|---|
| skeleton (A) | (mass %) | solid (mgKOH/g) | b8 | b9 | b10 | Ex. b11 | Ex. b12 | Ex. b13 |
| (Ex. a1) | 46 | 35 | | | 70 | 70 | | |
| (Ex. a2) | 50 | 40 | | | | | 70 | |
| (Ex. a3) | 50 | 20 | | | | | | |
| (Ex. a4) | 50 | 60 | | | | | | |
| (Ex. a5) | 50 | 41 | | | | | | 80 |
| (Ex. a6) | 50 | 40 | | | | | | |
| (Ex. a7) | 51 | 40 | | | | | | |
| (Ex. a8) | 50 | 41 | 100 | | | | | |
| (Ex. a9) | 50 | 40 | | 100 | | | | |
| (Ex. a10) | 51 | 69 | | | | | | |
| (Ex. a11) | 50 | 99 | | | | | | |
| (Ex. a12) | 50 | 90 | | | | | | |
| (Ex. a13) | 50 | 89 | | | | | | |
| (Ex. a14) | 50 | 20 | | | | | | 20 |
| Polycarboxylic acid resin | | | | | | | | |
| ZFR-1401H¹⁾ | 62 | 101 | | | 30 | | 20 | |
| CYCLOMER P ACA-250²⁾ | 50 | 70 | | | | 30 | 10 | |
| | Solid Concn. | Epoxy equivalent | | | | | | |
| Epoxy resin (B) | (mass %) | (g/eq) | | | | | | |
| EPIKOTE 828³⁾ | 100 | 189 | | | 12 | 9 | | |
| EPIKOTE 1002⁴⁾ | 100 | 650 | | | | | | |
| EPIKOTE 807⁵⁾ | 100 | 168 | | | | | 10.5 | |
| EPIKOTE 8034⁶⁾ | 100 | 290 | | | | | | |
| EPIKOTE YL7175-500⁷⁾ | 100 | 453 | | | | | | |
| EPIKOTE YL-6121H⁸⁾ | 100 | 175 | | | | | | |
| EPOTOHTO YDF-8170C⁹⁾ | 100 | 158 | | | | | | |
| EPOTOHTO YH-434C¹⁰⁾ | 100 | 120 | 5.5 | | | | | 5.3 |
| EPOLEAD GT401¹¹⁾ | 100 | 221 | | 9.5 | | | | |
| Inorganic and/or organic fine particles (C) | | | | | | | | |
| AEROSIL 380¹²⁾ | | | 2.5 | 2.5 | 2.5 | 2.5 | 2.5 | 2.5 |
| Curing agent (D) | | | | | | | | |
| Melamine | | | 1 | 1 | 1 | 1 | 1 | 1 |

¹⁾Bisphenol F epoxy acrylate manufactured by NIPPON KAYAKU CO., LTD.
²⁾Acrylic copolymer resin manufactured by DAICEL CHEMICAL INDUSTRIES, LTD.
³⁾Bisphenol A liquid epoxy resin manufactured by JAPAN EPOXY RESIN CO., LTD.
⁴⁾Bisphenol A solid epoxy resin manufactured by JAPAN EPOXY RESIN CO., LTD.
⁵⁾Bisphenol F liquid epoxy resin manufactured by JAPAN EPOXY RESIN CO., LTD.
⁶⁾Hydrogenated bisphenol F liquid epoxy resin manufactured by JAPAN EPOXY RESIN CO., LTD.
⁷⁾Manufactured by JAPAN EPOXY RESIN CO., LTD.
⁸⁾Biphenyl epoxy resin manufactured by JAPAN EPOXY RESIN CO., LTD.
⁹⁾Bisphenol F epoxy resin manufactured by Tohto Kasei Co., Ltd.
¹⁰⁾Amine epoxy resin manufactured by Tohto Kasei Co., Ltd.
¹¹⁾Alicyclic epoxy resin manufactured by DAICEL CHEMICAL INDUSTRIES, LTD.
¹²⁾Silica fine particles manufactured by Japan Aerosil Co., Ltd. (average particle diameter: not more than 0.2 μm)

TABLE 2
Properties of cured films (1)

| | | | | | | | | | | Ex. | Ex. | Ex. | Ex. |
|---|---|---|---|---|---|---|---|---|---|---|---|---|---|
| | Ex. b1 | Ex. b2 | Ex. b3 | Ex. b4 | Ex. b5 | Ex. b6 | Ex. b7 | Ex. b8 | Ex. b9 | b10 | b11 | b12 | b13 |
| Adhesion | 0 | 0 | 0 | 0 | 0 | 0 | 0 | 0 | 0 | 0 | 0 | 0 | 0 |
| Warpage | AA | AA | AA | AA | AA | AA | AA | AA | AA | AA | AA | AA | AA |
| Flexibility | AA | AA | AA | AA | AA | AA | AA | AA | AA | AA | AA | AA | AA |
| Plating resistance | AA | AA | AA | AA | AA | AA | AA | AA | AA | AA | AA | AA | AA |
| (tin plating) | | | | | | | | | | | | | |
| Soldering heat | AA | AA | AA | AA | AA | AA | AA | AA | AA | AA | AA | AA | AA |
| resistance | | | | | | | | | | | | | |
| Long-term reliability | AA | AA | AA | AA | AA | AA | AA | AA | AA | AA | AA | AA | AA |

TABLE 3
Composition of curable compositions (parts by mass) (2)

| Polyurethane resin without | Solid | Acid value of | Comp. | Comp. | Comp. | Comp. | Comp. | Comp. | Comp. | Comp. |
|---|---|---|---|---|---|---|---|---|---|---|
| polybutadiene | Concn. | solid | Ex. | Ex. | Ex. | Ex. | Ex. | Ex. | Ex. | Ex. |
| skeleton | (mass %) | (mgKOH/g) | b1 | b2 | b3 | b4 | b5 | b6 | b7 | b8 |
| (Comp. Ex. a1) | 51 | 40 | 100 | | | | | | | |
| (Comp. Ex. a2) | 50 | 68 | | 100 | | | | | | |
| (Comp. Ex. a3) | 50 | 40 | | | 100 | | | | | |
| (Comp. Ex. a4) | 50 | 40 | | | | 100 | | | | |
| (Comp. Ex. a5) | 50 | 40 | | | | | 100 | | | |
| Polycarboxylic acid resin | | | | | | | | | | |
| ZFR-1401H¹⁾ | 62 | 101 | | | | | | 100 | | |
| CYCLOMER P ACA-250²⁾ | 50 | 70 | | | | | | | 100 | |
| | Solid | Epoxy | | | | | | | | |
| | Concn. | equivalent | | | | | | | | |
| Epoxy resin (B) | (mass %) | (g/eq) | | | | | | | | |
| EPIKOTE 828³⁾ | 100 | 189 | 8 | 14 | 8 | 8 | 8 | | | |
| EPIKOTE 1002⁴⁾ | 100 | 650 | | | | | | | | |
| EPIKOTE 807⁵⁾ | 100 | 168 | | | | | | 7 | 8 | |
| EPIKOTE 8034⁶⁾ | 100 | 290 | | | | | | | | |
| EPIKOTE YL7175-500⁷⁾ | 100 | 453 | | | | | | | | 140 |
| EPIKOTE YL-6121H⁸⁾ | 100 | 175 | | | | | | | | |
| EPOTOHTO YDF-8170C⁹⁾ | 100 | 158 | | | | | | | | |
| EPOTOHTO YH-434C¹⁰⁾ | 100 | 120 | | | | | | | | |
| EPOLEAD GT401¹¹⁾ | 100 | 221 | | | | | | | | |
| Inorganic and/or organic | | | | | | | | | | |
| fine particles (C) | | | | | | | | | | |
| AEROSIL 380¹²⁾ | | | 2.5 | 2.5 | 2.5 | 2.5 | 2.5 | 2.5 | 2.5 | 2.5 |
| Curing agent (D) | | | | | | | | | | |
| Melamine | | | 1 | 1 | 1 | 1 | 1 | 1 | 1 | 1 |

¹⁾Bisphenol F epoxy acrylate manufactured by NIPPON KAYAKU CO., LTD.
²⁾Acrylic copolymer resin manufactured by DAICEL CHEMICAL INDUSTRIES, LTD.
³⁾Bisphenol A liquid epoxy resin manufactured by JAPAN EPOXY RESIN CO., LTD.
⁴⁾Bisphenol A solid epoxy resin manufactured by JAPAN EPOXY RESIN CO., LTD.
⁵⁾Bisphenol F liquid epoxy resin manufactured by JAPAN EPOXY RESIN CO., LTD.
⁶⁾Hydrogenated bisphenol F liquid epoxy resin manufactured by JAPAN EPOXY RESIN CO., LTD.
⁷⁾Manufactured by JAPAN EPOXY RESIN CO., LTD.
⁸⁾Biphenyl epoxy resin manufactured by JAPAN EPOXY RESIN CO., LTD.
⁹⁾Bisphenol F epoxy resin manufactured by Tohto Kasei Co., Ltd.
¹⁰⁾Amine epoxy resin manufactured by Tohto Kasei Co., Ltd.
¹¹⁾Alicyclic epoxy resin manufactured by DAICEL CHEMICAL INDUSTRIES, LTD.
¹²⁾Silica fine particles manufactured by Japan Aerosil Co., Ltd. (average particle diameter: not more than 0.2 μm)

TABLE 4
Properties of cured films (2)

| | Comp. Ex. | Comp. Ex. | Comp. Ex. | Comp. Ex. | Comp. Ex. | Comp. Ex. | Comp. Ex. | Comp. Ex. |
|---|---|---|---|---|---|---|---|---|
| | b1 | b2 | b3 | b4 | b5 | b6 | b7 | b8 |
| Adhesion | 0 | 0 | 0 | 0 | 0 | 1 | 2 | 1 |
| Warpage | AA | CC | AA | CC | AA | CC | CC | AA |
| Flexibility | AA | CC | AA | CC | AA | CC | CC | AA |
| Plating resistance | CC | AA | CC | CC | CC | CC | CC | CC |
| (tin plating) | | | | | | | | |
| Soldering heat | CC | AA | AA | AA | AA | AA | AA | CC |
| resistance | | | | | | | | |
| Long-term reliability | AA | AA | CC | AA | AA | CC | AA | CC |

### INDUSTRIAL APPLICABILITY

The carboxyl group-containing polyurethane (A) and the heat-curable resin composition have superior properties as materials of solder resist inks capable of giving cured products excellent in adhesion with substrates, low warpage, flexibility, plating resistance, soldering heat resistance and long-term reliability at high temperatures and high humidities. The carboxyl group-containing polyurethane (A) of the present invention can find uses in the fields such as heat-curable resins with superior flexibility for overcoating flexible circuits, electrical insulating materials such as heat-curable solder resists and layer insulation materials with superior insulating properties, IC and SLSI encapsulating materials, and laminates. The heat-curable resin composition can find uses in the fields such as electrical insulating materials such as solder resists and interlayer insulation films, IC and SLSI encapsulating materials, and laminates.

The carboxyl group-containing polyurethane, the solution of carboxyl group-containing polyurethane and the heat-curable resin composition can produce resist inks more inexpensively than the conventional liquid polyimide inks. Protective films from the conventional resist inks suffer warpage due to large cure shrinkage and post-curing cooling shrinkage, and consequently the yield is low. The resist ink according to the present invention enables inexpensive and efficient production of protective films that can achieve a tradeoff between the low warpage and the plating resistance and soldering heat resistance, as well as excellent long-term insulating properties at high temperatures and high humidities.

1. A carboxyl group-containing polyurethane (A) produced from a polyol (b) containing at least 10 mol % (relative to the total (100 mol %) of the polyol (b)) of a polyol (b1) which:
(i) has a number-average molecular weight of 500 to 50,000;
(ii) has 1 to 10 hydroxyl groups per molecule; and
(iii) is one or a combination of two or more polyols selected from the group consisting of polybutadiene polyol, polyisoprene polyol, hydrogenated polybutadiene polyol and hydrogenated polyisoprene polyol.

2. The carboxyl group-containing polyurethane (A) according to claim 1 produced by reacting:
(a) a polyisocyanate compound;
(b) a polyol (b) containing at least 10 mol % (relative to the total (100 mol %) of the polyol (b)) of a polyol (b1) which:
(i) has a number-average molecular weight of 500 to 50,000;
(ii) has 1 to 10 hydroxyl groups per molecule; and
(iii) is one or a combination of two or more polyols selected from the group consisting of polybutadiene polyol, polyisoprene polyol, hydrogenated polybutadiene polyol and hydrogenated polyisoprene polyol;
(c) a carboxyl group-containing dihydroxy compound;
(d) an optional monohydroxy compound (other than the polyol (b)); and
(e) an optional monoisocyanate compound.

3. The carboxyl group-containing polyurethane (A) according to claim 2, wherein the polyisocyanate compound (a) contains at least 10 mol % relative to the total (100 mol %) thereof of an alicyclic compound of 6 to 30 carbon atoms except the carbon atom in the isocyanate group (NCO group).

4. The carboxyl group-containing polyurethane (A) according to claim 2, wherein the polyisocyanate compound (a) is one or a combination of two or more polyisocyanate compounds selected from the group consisting of 1,4-cyclohexane diisocyanate, isophorone diisocyanate, methylenebis(4-cyclohexyl isocyanate), cyclohexane-1,3-dimethylene diisocyanate and cyclohexane-1,4-dimethylene diisocyanate.

5. The carboxyl group-containing polyurethane (A) according to claim 1, wherein the polyol (b) contains at least 70 mol % relative to the total (100 mol %) thereof of polybutadiene with 1,2-repeating units and/or a hydride thereof.

6. The carboxyl group-containing polyurethane (A) according to claim 1, wherein the polyol (b) is polybutadiene polyol and/or hydrogenated polybutadiene polyol having a number-average molecular weight of 500 to 5,000 and 2 to 4 hydroxyl groups per molecule.

7. The carboxyl group-containing polyurethane (A) according to claim 2, wherein the dihydroxy compound (c) is 2,2-dimethylolpropionic acid and/or 2,2-dimethylolbutanoic acid.

8. The carboxyl group-containing polyurethane (A) according to claim 2, wherein the monohydroxy compound (d) is one or a combination of two or more monohydroxy compounds selected from the group consisting of 2-hydroxyethyl acrylate, 2-hydroxyethyl methacrylate, allyl alcohol, glycolic acid and hydroxypivalic acid.

9. The carboxyl group-containing polyurethane (A) according to claim 2, wherein the monohydroxy compound (d) is one or a combination of two or more monohydroxy compounds selected from the group consisting of methanol, ethanol, n-propanol, isopropanol, n-butanol, isobutanol, sec-butanol and t-butanol.

10. The carboxyl group-containing polyurethane (A) according to claim 1, wherein the polyurethane has a number-average molecular weight of 1,000 to 200,000 and an acid value of 5 to 120 mgKOH/g.

11. The carboxyl group-containing polyurethane (A) according to claim 1, wherein the polyurethane has a number-average molecular weight of 2,000 to 60,000 and an acid value of 10 to 70 mgKOH/g.

12. A solution of carboxyl group-containing polyurethane comprising:
the carboxyl group-containing polyurethane (A) of claim 1; and
a solvent that is free of basic compounds and has a boiling point of not less than 120° C.

13. The solution of carboxyl group-containing polyurethane according to claim 12, wherein the solvent is one or a combination of two or more solvents selected from the group consisting of toluene, xylene, ethylbenzene, nitrobenzene, isophorone, diethylene glycol dimethyl ether, ethylene glycol diethyl ether, propylene glycol methyl ether acetate, propylene glycol ethyl ether acetate, dipropylene glycol methyl ether acetate, diethylene glycol ethyl ether acetate, methyl methoxypropionate, ethyl methoxypropionate, methyl ethoxypropionate, ethyl ethoxypropionate, n-butyl acetate, isoamyl acetate, ethyl lactate, cyclohexanone, N,N-dimethylformamide, N,N-dimethylacetamide, N-methylpyrrolidone, γ-butyrolactone and dimethylsulfoxide.

14. The solution of carboxyl group-containing polyurethane according to claim 12, wherein the solid concentration is in the range of 30 to 80 wt %.

15. A heat-curable resin composition comprising:
(A) 100 parts by mass of the carboxyl group-containing polyurethane resin of claim 1; and
(B) 1 to 100 parts by mass of an epoxy resin.

16. The heat-curable resin composition according to claim 15, wherein the epoxy resin (B) is one or a combination of two or more epoxy resins selected from the group consisting of bisphenol A epoxy resins, bisphenol F epoxy resins, phenol novolak epoxy resins, o-cresol novolak epoxy resins, biphenyl epoxy resins, amine epoxy resins, heterocyclic epoxy resins and alicyclic epoxy resins.

17. The heat-curable resin composition according to claim 15, wherein the carboxyl group-containing polyurethane resin (A) has an acid value in the range of 5 to 120 mgKOH/g.

18. The heat-curable resin composition according to claim 15, wherein the equivalent ratio of the epoxy groups in the epoxy resin (B) is 0.2 to 2 relative to the carboxyl groups in the carboxyl group-containing polyurethane resin (A).

19. The heat-curable resin composition according to claim 15, further comprising inorganic fine particles and/or organic fine particles (C) in an amount of 1 to 90 parts by mass based on 100 parts by mass of the carboxyl group-containing polyurethane resin (A).

20. The heat-curable resin composition according to claim 15, further comprising a curing agent (D) in an amount of 0.1 to 25 parts by mass based on 100 parts by mass of the carboxyl group-containing polyurethane resin (A) and the epoxy resin (B) combined.

21. The heat-curable resin composition according to claim 20, wherein the curing agent (D) is at least one compound selected from the group consisting of amines, quaternary ammonium salts, acid anhydrides, polyamides, nitrogen-containing heterocyclic compounds and organometallic compounds.

22. A coating paste comprising:
the heat-curable resin composition of claim 15; and
a nitrogen-free polar solvent.

23. A solder resist ink comprising the heat-curable resin composition of claim 12.

24. A cured product produced by curing the solder resist ink of claim 23.
